(19) United States
(12) Patent Application Publication
(10) Pub. No.: US 2002/0147799 A1
(43) Pub. Date: Oct. 10, 2002

(54) Remote laboratory experimentation

(76) Inventors: Bassem Abdo Alhalabi, Boca Raton, FL (US); Mohammad Khalid Hamza, Boca Raton, FL (US)

Correspondence Address: Gregory A. Nelson, Akerman, Senterfitt & Eidson, P.A., Post Office Box 3188, West Palm Beach, FL, 33402-3188, US

(21) Appl. No.: 10/114,405

(22) Filed: Apr. 2, 2002

Related U.S. Application Data
(60) Provisional application No. 60/281,229, filed on Apr. 2, 2001.

(51) Int. Cl. G06F 15/16; G06F 15/177

(52) U.S. Cl. 709/220; 709/250

(57) ABSTRACT

A method for hosting a remote laboratory experiment, can includes the steps of: receiving from a remote computing node through a computer communications network, student-specified control component configuration parameters; specifying a component configuration parameter filter; configuring at least one control component to provide an input to an experimental configuration according to the received configuration parameters; acquiring experimental data from the experimental configuration; and, providing the acquired experimental data to the remote computing node through the computer communications network. The method can further include the steps of: acquiring an image of the experimental configuration; and, transmitting the acquired image to the remote computing node through the computer communications network.

### CROSS REFERENCE TO RELATED APPLICATIONS

This patent application claims the priority of U.S. Provisional Patent Application Serial No. 60/281,299 filed Apr. 2, 2001.

### BACKGROUND OF THE INVENTION

1. Technical Field

This invention relates to the field of distance education, and more particularly to a system and method for remote laboratory experimentation.

2. Description of the Related Art

The Internet has become a great source of information and continues to grow at an accelerated rate. In the United States alone, over 100 million adults now access the Internet routinely, and by 2003, the number of Internet users worldwide has been projected to exceed 500 million. As will be apparent to most, the Internet has made our world much smaller by providing constant, up-to-date, instantaneously transmittable information that can be cost-effectively reproduced. In consequence of this phenomenon, one aspect of the Internet—on-line distance learning—has experienced tremendous growth in recent years.

As an $8.25 billion industry, distance learning has attracted many globally wellknown academic institutions. Distance learning as it is practiced today focuses on developing and supplying educational materials through the Internet in the form of books, reading matters, visual aids and explanations. To supplement these distributed educational materials, interactive group discussions, collaborative class projects and on-line help can be offered so that the student can experience an “in-class feeling”. Finally, the extent of learning by the student can be gauged by the instructor by way of out-of-class assignments as is normally done in an on-campus academic program.

Generally, the method of teaching adopted in virtual education can be classified as synchronous or asynchronous, wherein each enjoys some unique advantages. In the synchronous mode, students actively engage in collaborative learning to simultaneously arrive at solutions to specific problems. To facilitate the synchronous mode in on-line distance education, chat rooms are used wherein students in a group can exchange views and clarify infirm concepts with the active participation of a guide or teacher. Threaded discussions also can be used to facilitate a synchronous mode system where messages correlate to topics in a forum. In the treaded discussion model, students and the instructor can discuss topics interactively.

By comparison, the asynchronous mode of distance learning frees the student from group interaction and allows the student to absorb the material at the student's own pace. By relieving the student of group interaction, the student can repeatedly review the material until the student understands and feels confident of sitting for a examination. In any case, both the synchronous and asynchronous modes are popular among distance learning methodologies among students and academic institutions alike.

The realization that distance education does not require an on-campus facility has given rise to the notion of a virtual university. The term “virtual” indicates that the university may or may not have a physical campus. These virtual universities offer entire degree programs and associated course materials can be delivered exclusively on-line. In most cases, virtual universities effectively can offer the same primary tools of learning as in the case of established academic institutions offering distance education programs. Thus, virtual universities have emerged as an equally acceptable alternative to the conventional academic institution. Accordingly, so long as students and teachers maintain proper interactivity in the virtual university, the concept of a virtual campus is likely to succeed.

In spite of the tremendous success in the development and marketing of distance learning and its anticipated future, one major challenge still remains. Specifically, some specialized fields of study remain far from being able to fully partake in distance education. For example, in engineering, science and technology programs where laboratory sessions are indispensable, students cannot complete degree requirements without attending an associated physical campus that has actual laboratory facilities.

This especially can be important in specialized courses such as Logic Design, Microprocessors and Electronic Circuits, where the hands-on experience of the laboratory experiment can be crucial to the understanding of basic course concepts. Any amount of reading material is no substitute to the experience that one gains while performing actual laboratory experiments. In fact, describing an experiment or even observing someone else performing the experiment falls far short of the impact of actual laboratory experimentation needed for proper education.

Four alternative methods to laboratory experimentation have been proposed that are currently being employed in the market to place laboratories on-line. These methods include the distribution of videotapes and home experiment kits, the provision of temporary facilities for performing experiments in the student locale, and the use of simulation software. In the case of distributing videotapes, if presenting a demonstration of a simple experiment is enough to reach a student in full measure, then a videotape showing the experiment can be mailed to the student. The comprehension of the student further can be tested by an on-line examiner who asks searching questions to make sure that the student has thoroughly understood the concept demonstrated by the videotaped experiment.

By comparison, if hands-on experience is considered essential to the understanding of a concept, then a specially designed home experimentation kit can be sent to the student along with relevant material required by the student for using the home kit. Notwithstanding, in the case of engineering courses such as Logic Design, and Microprocessors, providing home kits can be problematic in regard to the cost of each home kit. Furthermore, students typically do not possess expensive ancillary tools necessary to perform experiments such as oscilloscopes, volt meters and power supplies. Finally, the geographic distance between classroom and student can make loaning expensive laboratory tools difficult in view of timing the shipment of tools to various students.

A third and sometimes preferred substitute for on-campus laboratory experimentation is to make available physical laboratory facilities near the student locale. For example, accredited colleges in the vicinity of the student locale can offer an experimentation facility on a scheduled or as needed basis. Alternatively, students can travel to the on-campus location periodically to conduct actual experiments.

Intensive laboratory activities during this period helps the students to finish the requirements needed by the course or may help them to finish the remaining part in their homes in a satisfactory manner. Although this alternative can be by far the most satisfactory from the student point of view, this alternative also suffers from several disadvantages.

For instance, the distance between the student locale and the on-campus laboratory facility can inhibit the success of a distance education program. Specifically, long distance travel can add substantially to the cost of a course making it less affordable by the large majority of potential students. Moreover, the academic institution offering the course through distance education can find it difficult to free facilities for a short duration, which in turn can affect traditional on-campus students.

Among the four alternatives to on-site laboratory experimentation, simulation software has been identified as the best alternative, as it is highly portable and cost effective. Hence, many distance learning programs provide software simulations in substitute for actual laboratory experimentation. Software simulations intend to deliver laboratory facilities to the door of the student.

For example, the Multiverse Project (Institute for Computer Based Learning, 1999) developed student-friendly software that provides step-by- step explanations of lab assignments and expected results of the experiments. This process offers the student additional time to complete the course work. Simulation software which heretofore has been available through the Internet has, to some extent, met the requirements of distance learning, yet suffers from several shortcomings.

First, the design of a simulation depends largely on the student's perception as anticipated by the simulation designer. Potentially, the various procedures that the student must perform might be more advanced than what the student can capably perform. Also, one step performed out of sequence can render the entire exercise a futile attempt. Finally, the knowledge gained by a simulation experiment largely depends on the design, authenticity, limitations, and cost of the software. Simulation software at its best might only produce an approximation that can yield erroneous results. Under these conditions, the understanding of the student will depend on the quality of the software more than the comprehension capability of the student.

As such, the results of experiments conducted through simulation software must be programmed for use within the scope of distance learning parameters. This learning scenario places the students in an environment where they must adhere to prescribed inputs that deny the freedom to experiment with disparate criteria that are more likely to accompany a real laboratory setting. The thrill of spontaneity from autonomous experimentation vanishes under such orchestrated and antiseptic conditions. Interest, excitement, and curiosity can ebb, directly affecting the student's ability to absorb new information. Importantly, as many educators will attest, when curiosity ebbs and listlessness prevails, students rush through prescribed steps to arrive at the ultimate results. Such behavior deprives the student the opportunity to appreciate the concepts learned in the act of experimentation.

Simulations also introduce an element of fiction. The knowledge gained as a result of simulation is narrow and the freedom to study various possibilities is wanting. There are no answers to “what if,” because the student simply cannot attempt them. Accordingly, the ability of the student to produce genuine thinking or to try different approaches to the experiment is absent. The students are limited by limitations of the software applications being used.

Using software that produces the best results depends on the student's understanding of its usage. A student who clearly understands the software is more likely to achieve better results than the student whose understanding falls short. Hence, the proficiency of software becomes more significant than the proficiency of the student. This outcome is undesirable. For these reasons, simulation is not a suitable substitute for actual laboratory experimentation. Hence, what is needed is an effective substitute for actual laboratory experimentation in a distance education program.

### SUMMARY OF THE INVENTION

The present invention is a remote laboratory experimentation system and method in which students can remotely perform over a computer communications network an actual laboratory experiment through the use of real instrumentation and data acquisition equipment positioned in a remote laboratory. In operation, students can connect to a communicatively linked computing node in a remote laboratory which can be configured to control experiment devices in the remote lab. Once connected to the remote laboratory, students can control inputs to an experiment by remotely controlling input devices, such as a power supply, and by remotely controlling output sensing devices, such as a digital oscilloscope, flow meter or voltmeter.

Recent innovative technologies include devices that allow programmable connections of multiple electronic components. Hence, more complex laboratory experiment setups are possible, such as those used in a conventional Logic Design course required of Computer Science and Computer Engineering undergraduate students. Finally, for visually observing experimental effects, a real-time camera interface is incorporated into the remote laboratory experimentation system. The camera includes remotely controllable direction and zoom controls.

To facilitate the interaction between lab assistants and students, a synchronous network communications system can be used to interactively explain the laboratory experiment and any problems encountered in performing the experiment. The synchronous network communications system allows students logged either into a lab session or into an instructor's remote office system to interact using an electronic whiteboard. The electronic whiteboard not only allows a moderator to graphically annotate diagrams and equations on the whiteboard, but also allows any student remotely logged into the system to graphically annotate diagrams and equations on the whiteboard.

A remote laboratory experiment system configured in accordance with the inventive arrangements herein can stimulate higher order thinking skills in ways that simulation software cannot. On-site laboratory environments involve the student's individual senses and learning abilities that foster the learning process. The element of reality is included within remote laboratory environments to involve the student as a learner, not an observer. This reality based learning experience is crucial in the fields of practical studies such as science and engineering, where there may be no acceptable prominence for simulated environments.

Hence, a remote laboratory experimentation system configured in accordance with the inventive arrangements can include an experimental configuration; at least one configurable control component for providing an input to the experimental configuration, and at least one data acquisition device for acquiring experimental data from the experimental configuration; a computing device for controlling the at least one configurable control component and the at least one data acquisition device; a network interface for communicatively linking the computing device to a computer communications network; and, a network distributable user interface for providing access to the computing device through the computer communications network. The remote laboratory experimentation system further includes a remotely controllable camera communicatively linked to the computing device. Finally, the remote laboratory experimentation system includes a white-board component for providing interactive annotations of a group document; and, a chat-room component for hosting an on-line conference.

A method for hosting a remote laboratory experiment, can include the steps of: receiving from a remote computing node through a computer communications network, student-specified control component configuration parameters; configuring at least one control component to provide an input to an experimental configuration according to the received configuration parameters; acquiring experimental data from the experimental configuration; and, providing the acquired experimental data to the remote computing node through the computer communications network. The method can further include the steps of: acquiring an image of the experimental configuration; and, transmitting the acquired image to the remote computing node through the computer communications network.

### BRIEF DESCRIPTION OF THE DRAWINGS

There are presently shown in the drawings embodiments which are presently preferred, it being understood, however, that the invention is not limited to the precise arrangements and instrumentalities shown, wherein:

FIG. 1 is a schematic representation of a remote laboratory experimentation system which has been configured in accordance with the inventive arrangements;

FIGS. 2A and 2B, taken together, are a pictorial representation of a remote laboratory experimentation system configured to perform an electrical circuits experiment;

FIGS. 3A and 3B, taken together, are a pictorial representation of a remote laboratory experimentation system configured to perform a basic physics experiment;

FIGS. 4A and 4B, taken together, are a pictorial representation of a remote laboratory experimentation system configured to perform a materials experiment;

FIG. 5 is a pictorial representation of a synchronous mode aspect of the remote laboratory experimentation system configured in accordance with the inventive arrangements; and,

FIGS. 6A and 6B, taken together, are a pictorial representation of a remote laboratory experimentation system configured to perform a mechanical engineering experiment.

### DETAILED DESCRIPTION OF THE INVENTION

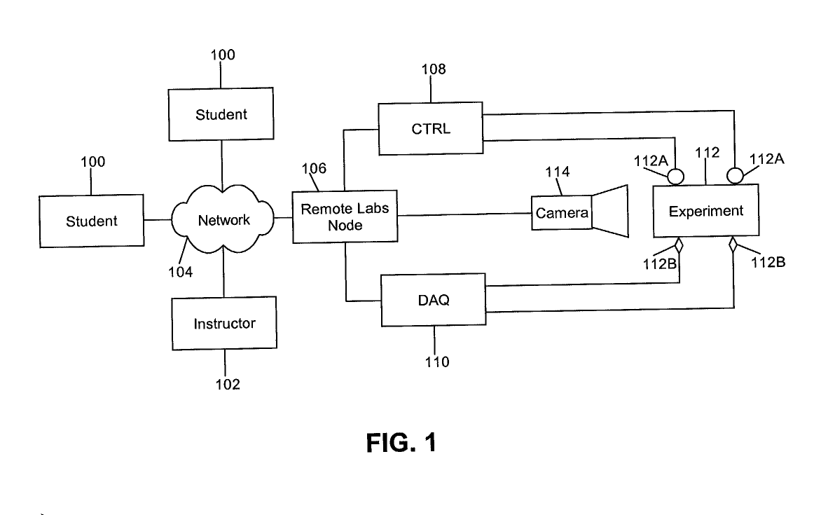

FIG. 1 illustrates a remote laboratory experimentation system configured in accordance with one aspect of the present invention. As shown in FIG. 1, the remote laboratory experimentation system can include experimental components arranged in a laboratory experiment configuration 112 in a remote laboratory. The configuration 112 can have one or more inputs 112A and one or more test points 112B. One or more configurable control components 108 can be applied to the inputs 112A to effect an operable parameter of the laboratory experiment configuration 112.

For example, configurable control components 108 can be applied to inputs to a signal generator, a motorized incline or a gas supply. Additionally, one or more data acquisition devices 110 can be applied to the test points 112B which can be, for example an oscilloscope, a volt meter, a flow meter, etc. Both the data acquisition devices 110 and configurable control components 108 can be communicatively linked to a computing node 106 in the remote laboratory. Finally, a remotely controllable camera 114 can be included and communicatively linked to the computing node 106.

Students 100 can obtain a communicative link to the computing node 106 over a data communications network 104, for instance a local area network, a wide area network, or a public network such as the Internet. Additionally, one or more instructors 102 also can obtain a communications link to the computing node 106 over the data communications network 104. Once connected, each student can operate the configurable control components 108 so as to perform an experiment in accordance with the instructions of a laboratory exercise. Additionally, each student can operate the data acquisition devices 110 so as to perform data measurements at particular test points 112B, also in accordance with the instructions of the laboratory exercise. Finally, in the case where a remotely controllable camera 114 is included in the remote laboratory, the students and instructors can operate the camera 114 so as to visually perceive the progress of the experiment. Importantly, the present invention can be illustrated in reference to specific embodiments described herein.

Particular embodiments of the present invention can include an electric circuit element characterization experiment for electrical engineering students, a logic design experiment for computer engineering students, a motion and friction experiment for physics students and a metallic elasticity experiment for chemistry and materials science students. The present invention, however, is not limited in regard to the particular application thereof. Rather, the present invention can be applied to any experimental setting including psychology experiments, biology experiments, etc.

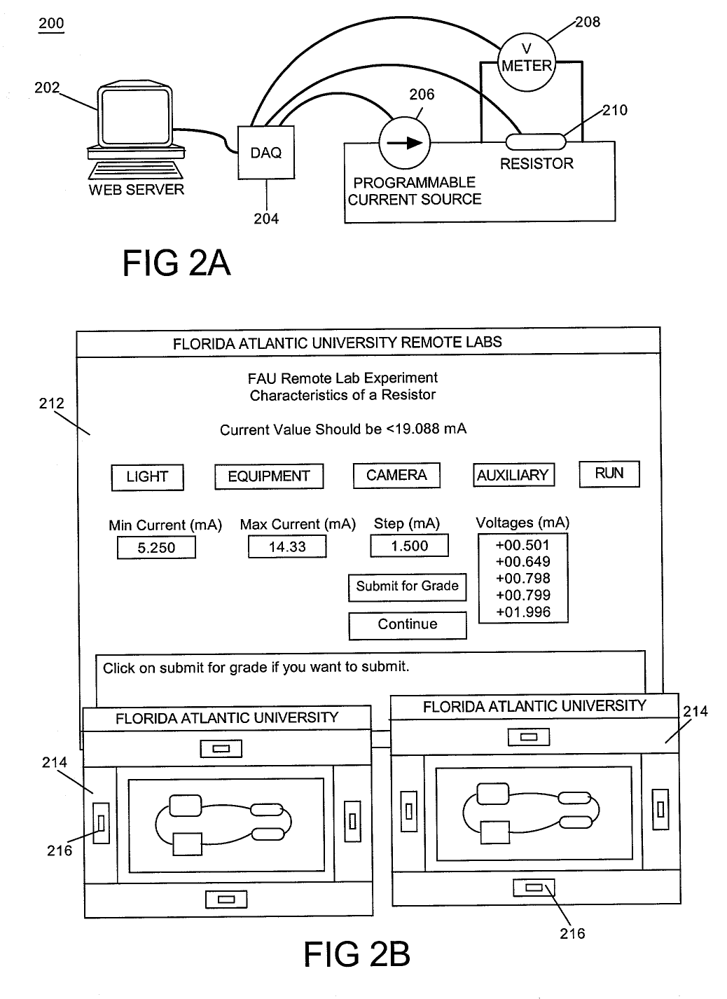

FIGS. 2A and 2B, taken together, are a pictorial representation of a remote laboratory experimentation system configured to perform an electrical circuits experiment. A remote laboratory experimentation system 200 configured to perform an electrical circuits experiment in accordance with the present invention. The remote experimentation system 200 can include a Web server 202, a data acquisition and control board 204, and an electric circuit element analysis experiment configuration including a programmable current source 206, a volt meter 208 and a resistor 210 arranged in a current loop.

The actual experimental setup can include, for example, a data acquisition and control board having an 8-bit digital I/O port, an analog input module, and an analog output module. In another arrangement, a standard computer port can be used for I/O in lieu of, or along with, the data acquisition and control board 204. Examples of I/O ports can include serial ports as well as parallel ports. Additionally, the Web server 202 or the data acquisition and control board 204. Further, digital I/O lines can be used to turn on the lights in the remote laboratory, power on the testing equipment, and/or to select a resistor under test.

Students remotely linked to the Web server 202 can interact with the experimentation system 200 through graphical user interface (GUI) 212, such as a Web browser. The GUI 212 can be used by students to perform and analyze the numerous experiments performed by the experimentation system 200. The GUI 212 also can be Web-enabled to allow for experimentation from remote locations. Finally, a remotely controllable camera can be manipulated by students through a camera window 214 to view the progress of the experiment.

Specifically, students performing an electrical experiment can specify a sequence of current values, for example a minimum current of 05.050 mA and maximum current of 14.333 mA with a step of 1.500 mA, to be injected through a resistor 210 under study. When suitable current values have been specified, current injection can be performed through an analog output module linked to the programmable current source 206 through an interface. As would expected, for every current value injected through the resistor 210, the corresponding voltage drop can be read from across the resistor 210 by a voltmeter interfaced to the data acquisition module 204 through an analog input module. The voltage drop measurement can be transmitted back to the remote student and displayed in the Web browser 212. Finally, students can observe the actual experiment through the controllable camera windows 214, which can include panning and zooming controls 216.

Once the students have observed the actual experiment and the experimental data, the students can plot the current/voltage (I/V) characteristic graph which relates to the values of voltage compared to corresponding current values. As will be recognized by any electrical engineer, if the I/V curve is a straight line, the student can rightfully conclude that the resistor under study has a linear coefficient. By comparison, if at high current values, the curve begins to bend, the student can rightfully concludes that the resistor has lost its linearity due to a thermal effect. Notably, where a temperature sensor is added to sense the resistor temperature, more specific information can be concluded regarding the characteristics of the IN curve which then includes the thermal behavior.

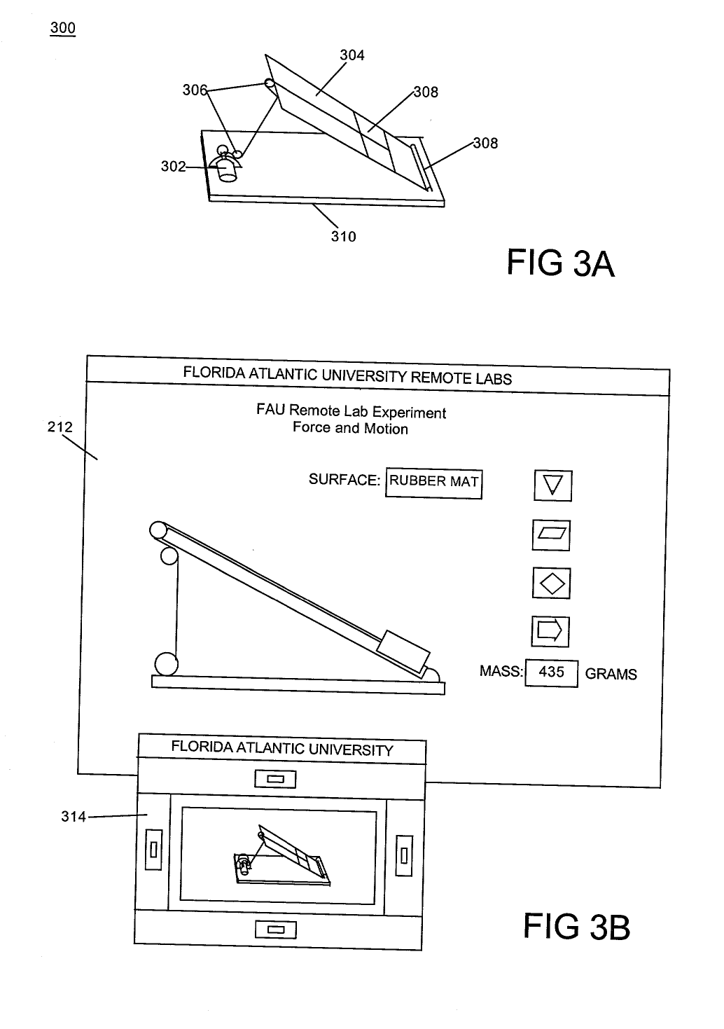

FIGS. 3A and 3B, taken together, are a pictorial representation of a remote laboratory experimentation system configured to perform a force and motion experiment. As will be recognized by one skilled in the art, the force and motion experiment consists of two major components. The first component, illustrated in FIG. 3A, includes an experimental device 300 formed of a ramp 304, pulleys 306, a motor 302, multiple sensors and controls 308 and a micro-controller 310 to enable force and motion testing. The micro-controller 310 can act as the electronic stage between the mechanical/physical components and software executing in a computing node.

The second component of the experiment can include Graphical User Interface (GUI) 312. An exemplary GUI and some of its functions are detailed in FIG. 3B. The GUI 312 can be used by the students to perform and analyze the numerous force and motion experiments of the experimental device 300. As with the previously discussed electrical experiment, the GUI 312 also can be Web-enabled to allow for experimentation from remote locations and a remotely controllable camera can be manipulated by students through a camera window 314 to view the progress of the experiment. In conjunction, the two components, experimental device 300 and GUI 312, comprise the force and motion remote experiment system.

By interchanging different aspects of the experimental device 300 and the GUI 312, instructors can vary the difficulty of the experiment. For instance, a sample experiment could allow younger students to experiment with the pulley and weight system. A more involved experiment could measure the power generated by the motor to lift an unknown weight up the incline. Students then could be asked to determine the weight of the object and or the coefficient of friction of a mat placed on the incline.

Data from the GUI 312 can be used to generate graphs of velocity and acceleration. Advanced tests can be conducted from a remote location via the Web. For example, a group of students could try and determine loads, angle and friction coefficients of the experimental device 300 by running remote tests via the GUI 312 without ever coming into contact with the experimental device 300. A second group of students could be responsible for setting up the experimental device 300 to challenge the first group, and visa-versa. Competitions can be established to identify which team of students can “out-stump” the other student teams.

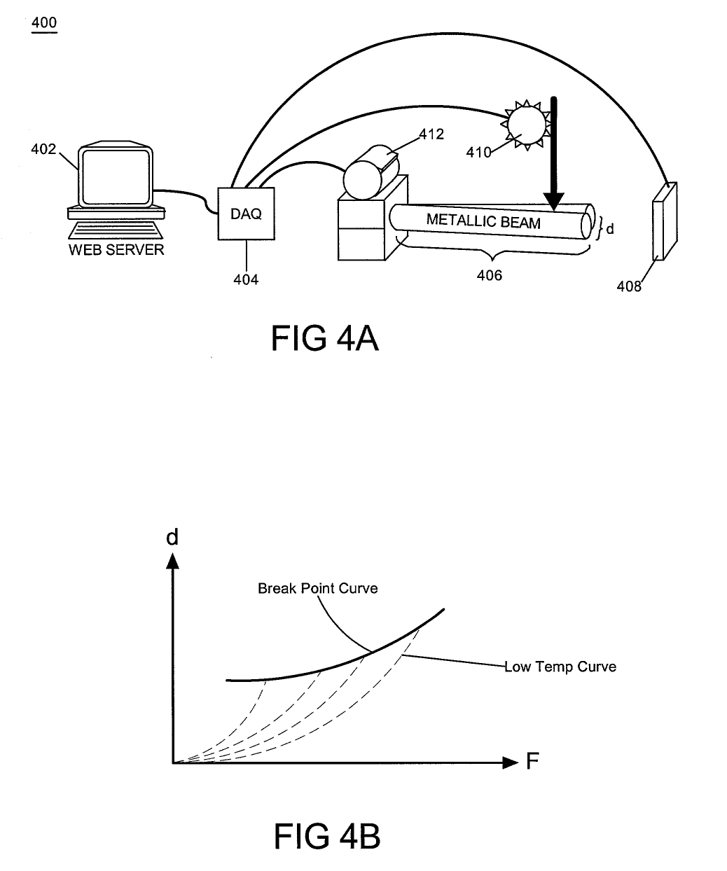

FIGS. 4A and 4B, taken together, are a pictorial representation of a remote laboratory experimentation system configured to perform a materials experiment. In the field of physics and material engineering, an experimental device 400 is shown which can test the elasticity of a metallic beam 406. A metallic beam 406 of known dimensions is mounted in horizontal position as shown in FIG. 4A. The free length of the beam 406 has the length L and cross-sectional area A.

The force controller 410 can be communicatively linked to, and remotely operate, a data acquisition board 404. On-line students can apply a sequence of known forces Fi on the free edge of the beam 406. Additionally, students can alter the temperature of the metallic beam 406 using hot air gun 412 which has a feedback sensor for measuring temperature. Subsequently, using the light reflection sensor 408, the students can measure the amount of displacement di which is proportionally due to the applied force at the current temperature.

The mathematical relationship of these quantities is depicted in the graph of FIG. 4B. For every temperature reading, the various readings of force Fi and displacement di are plotted on a graph. For every force value, after displacement is measured, the force can be removed to allow the beam 406 to restore to its original straight shape. Once the force F reaches a maximum value at which the beam 406 does not restore to its straight form (permanently bent), this last force reading is considered the breakpoint. After each break point, the beam 406 is automatically straightened by applying the same force backwards. From the graph students can visually observe the elastic behavior of a metallic beam 406 to determine if it is linear or nonlinear. The students also can learn how fast elasticity is lost to temperature increase.

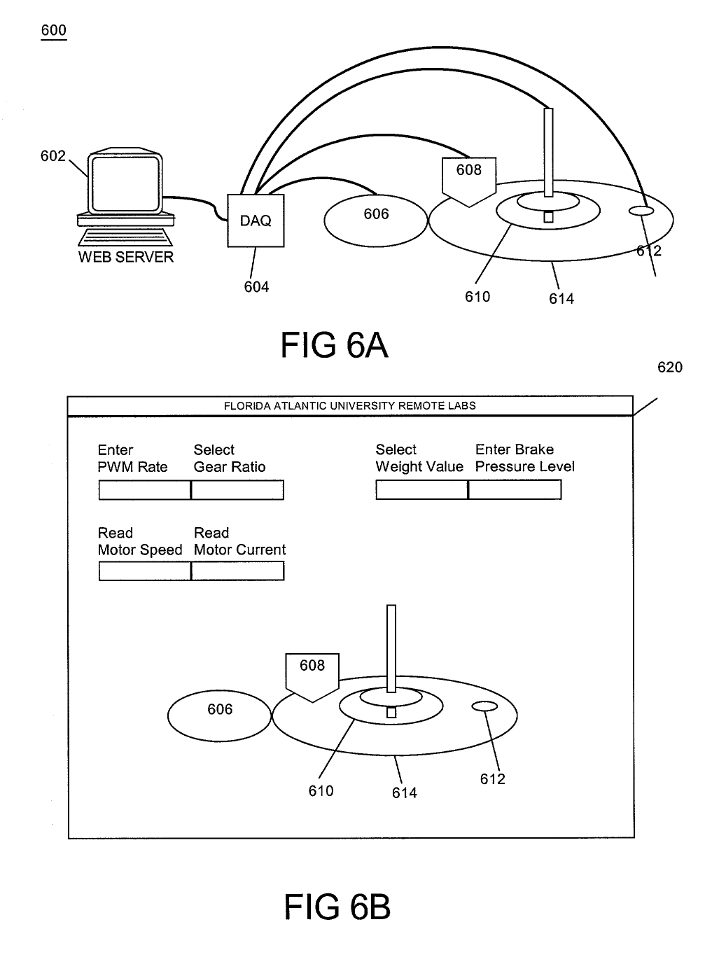

FIGS. 6A and 6B, taken together, illustrate a mechanical engineering experiment which has been configured in accordance with the present invention. In particular, a experimental setup 600 can include a rotating disc 614 controlled by a braking apparatus 612. The disc 614 can be controlled through the Web server 602 to rotate at varying speeds according to a pulse width modulated signal applied to the gearing apparatus 606. Varying weights 610 having varying frictional surfaces can be applied to the disc 614 to stall the motion of the disc.

Sensors 608 can monitor not only the speed of the disc 614, but also the positional aspects of the experiment. The control points for the gears 606, weights 610 and braking apparatus 612 can be communicatively linked to the Web server 602 through the data acquisition device 604. Values can be provided by students through the Web interface 620 shown in FIG. 6B. Additionally, the sensors 608 can provide sensed data to the Web server 602 over the communicative link. The sensed data can be viewed through the Web interface 620.

A logic design (LD) laboratory experiment configured in accordance with the inventive arrangements differs from other more physically grounded experiments in that LD laboratory experiments require less data acquisition and control. LD laboratory experiments involve electronic breadboards and interconnectivity logic. In a conventional LD laboratory experiment, students use breadboards to mount logic chips, such as NAND and NOR gates which the students can interconnect using breadboard wires. Subsequently, the students can connect the breadboard to a power supply and verify by observation whether the circuit is functional. If the circuit is not functioning, which is almost always the case for the first few trials, the students can rewire the breadboard and repeat the process.

During their physical presence in the LD laboratory, students are merely rewiring the breadboard, staging certain inputs, and observing the resulting output. If these three actions can be performed remotely, as they are in the present invention, the remote LD laboratory experiment becomes possible. In an LD laboratory experiment, the first and third experiment steps include the I/O portion which could be replaced by a standard computer interface with the proper instrumentation device. As a result, any computer communicatively linked to the standard computer interface can perform the I/O operations, even, for example, through the Internet.

Importantly, the use of a host computer in the foregoing instances ought not to be confused with well-known software simulation as in the present invention, unlike software simulation, students still physically manipulate the performance of the experiment through physically operating electronic components. Moreover, the students maintain the freedom to make any connections in the experiment that the students so choose. Unlike software simulations, in the present invention, the computer merely provides a front-end interface through which the students can lay out the connection on-screen and implement the layout on the board.

Importantly, to perform the second experiment step of wiring and rewiring, conventional breadboards can be replaced by interactive breadboards whose pins are connected to a programmable interconnect network controlled by a local computer with a corresponding software interface. A connection between any pin to any pin is accomplished through the software interface. If all necessary LD components (NANDs, NORs, Flip-Flops, etc. ) are placed on the interactive breadboard, then a full experiment can be conducted through the computer software interface without touching the breadboard.

Notably, an immediate advantage of the present invention of time sharing will be apparent to one skilled in the art when comparing the LD laboratory experiment of the present invention to a conventional LD laboratory experiment. Specifically, the actual run time for the LD laboratory experiment lasts momentarily for but a few seconds. Thus, many students can use the same LD laboratory experiment configuration seamlessly in a concurrent manner. In contrast, in a conventional LD laboratory experiment, students occupy the LD setup for hours just thinking and rewiring.

Finally, to facilitate the interaction between lab assistants and students, a synchronous network communications system can be used to interactively explain the laboratory experiment and any problems encountered in performing the experiment. The synchronous network communications system allows students logged either into a lab session or into an instructor's remote office system to interact using an electronic whiteboard. The electronic whiteboard allows a moderator to graphically annotate diagrams and equations on the whiteboard. Further, any student remotely logged into the system can graphically annotate diagrams and equations on the whiteboard.

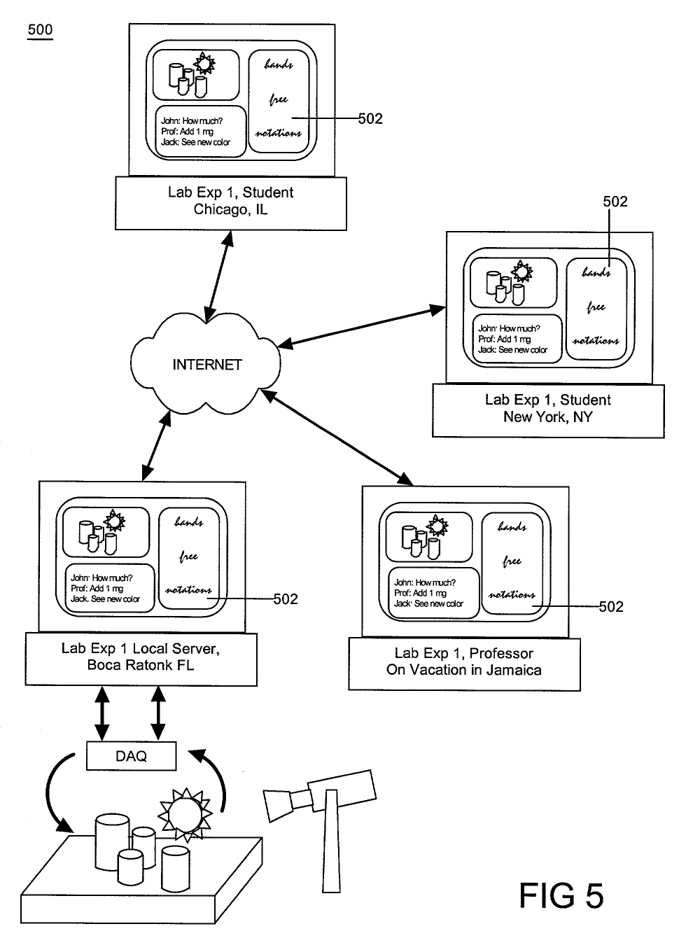

FIG. 5 is a pictorial representation of a synchronous mode aspect of the remote laboratory experimentation system 500 configured in accordance with the inventive arrangements. To facilitate proper interaction between students performing remote laboratory experiments and laboratory instructors, a Web-based application-sharing system can be provided for distance learning purposes. A major application of this system is to give teachers an added convenience in explaining their ideas to students while teaching classes online. With the provision to write freehand on the electronic whiteboard 502, a teacher can explain and illustrate ideas more effectively to the audience. This effect is similar to writing on a blackboard in a conventional classroom setting.

Notably, the present invention can be realized in hardware, software, or a combination of hardware and software. The method of the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or computer program means as in the present context means any expression, in any language, code or notation, of a set of instructions intended to cause a system having an information processing capability to perform a particular function either directly or after one or both of the following: a) conversion to another language, code or notation; b) reproduction in a different material form.

While the foregoing specification illustrates and describes the preferred embodiments of this invention, it is to be understood that the invention is not limited to the precise construction herein disclosed. The invention can be embodied in other specific forms without departing from the spirit or essential attributes. Accordingly, reference should be made to the following claims, rather than to the foregoing specification, as indicating the scope of the invention.

1. A remote laboratory experimentation system comprising:
a set of experimental components arranged to conduct an experiment;
at least one configurable control component able to modify individual ones of said experimental components, and at least one data acquisition device configured to acquire experimental data from said experiment;
a computing device communicatively linked to said at least one configurable control component and to said at least one data acquisition device, said computing device comprising a control module linked to said control component and said at least one data acquisition device through said communicative link;
a network interface able to communicatively link said computing device to a computer communications network; and,
a network distributable user interface through which user access to said computing device can be provided over said computer communications network.

2. The remote laboratory experimentation system of claim 1, wherein said network distributable user interface can receive user input commands and can pass said user input commands to said, at least one configurable control component over said communicative link.

3. The remote laboratory experimentation system of claim 1, wherein said network distributable user interface can receive said experimental data acquired by said data acquisition device and can present said experimental data to a user.

4. The remote laboratory experimentation system of claim 1, further comprising a remotely controllable camera communicatively linked to said computing device.

5. The remote laboratory experimentation system of claim 1, wherein said distributable user interface further comprises:
a white-board component for providing annotations from at least one user; and,
a chat-room component for hosting an on-line conference.

6. The remote laboratory experimentation system of claim 5, wherein said white-board component comprises logic for interactively annotating a group document.

7. The remote laboratory experimentation system of claim 6, wherein said logic comprises both asynchronous and synchronous operational modes.

8. A method for hosting a remote laboratory experiment, comprising the steps of: receiving from a remote computing node through a computer communications network, student-specified control component configuration parameters;
configuring at least one control component to provide an input to an experimental configuration according to said received configuration parameters;
acquiring experimental data from said experimental configuration; and,
providing said acquired experimental data to said remote computing node through said computer communications network.

9. The method of claim 8, further comprising the steps of:
acquiring an image of said experimental configuration; and,
transmitting said acquired image to said remote computing node through said computer communications network.

10. The method of claim 8, further comprising the steps of:
providing a white-board component for presenting annotations from at least one user; and,
providing a chat-room component for hosting an on-line conference.

11. The method of claim 10, further comprising the step of providing interactive annotations of a group document with said white-board component.

12. The method of claim 10, further comprising the step of providing both asynchronous and synchronous operational modes for said chat-room component.

13. A machine readable storage, having stored thereon a computer program incorporating a graphical user interface for hosting a remote laboratory experiment, said computer program having a plurality of code sections executable by a machine for causing the machine to perform the steps of:
receiving from a remote computing node through a computer communications network, student-specified control component configuration parameters;
configuring at least one control component to provide an input to an experimental configuration according to said received configuration parameters;
acquiring experimental data from said experimental configuration; and,
providing said acquired experimental data to said remote computing node through said computer communications network.

14. The machine readable storage of claim 13, further comprising code sections for causing the machine to perform the step of providing a configuration parameter filer to filter out user-specified control component configuration parameters that are potentially destructive to experimental equipment being used in said remote laboratory experiment.

15. The machine readable storage of claim 13, further comprising code sections for causing the machine to perform the steps of:
a acquiring an image of said experimental configuration; and,
transmitting said acquire d image to said remote computing node through said computer communications network.

16. The machine readable storage of claim 13, further comprising code sections for causing the machine to perform the steps of:
providing a white-board component for presenting annotations of at least one user; and,
providing a chat-room component for hosting an on-line conference.

17. The machine readable storage of claim 16, further comprising code sections for causing the machine to perform the step of providing interactive annotations of a group document with said white-board component.

18. The machine readable storage of claim 16, further comprising code sections for causing the machine to perform the step of providing both asynchronous and synchronous operational modes for said chat-room component.
